(19) United States
(12) Patent Application Publication
(10) Pub. No.: US 2025/0162034 A1
(43) Pub. Date: May 22, 2025

(54) INTEGRATED ADDITIVE MANUFACTURING AND THERMAL PROCESSING METHOD FOR MICROSTRUCTURE CONTROL

(71) Applicant: KVA Technologies, Borrego Springs, CA (US)

(72) Inventors: Daniel S. Codd, San Diego, CA (US); Joseph John McCrink, Carlsbad, CA (US)

(21) Appl. No.: 18/888,895

(22) Filed: Sep. 18, 2024

Related U.S. Application Data
(60) Provisional application No. 63/539,028, filed on Sep. 18, 2023.

(51) Int. Cl. B22F 10/38; B22F 10/22; B22F 10/64; B22F 12/90; B33Y 10/00; B33Y 30/00; B33Y 40/20; B33Y 50/02; C22C 38/18

(52) U.S. Cl. CPC B22F 10/38; B22F 10/22; B22F 10/64; B22F 12/90; B33Y 10/00; B33Y 30/00; B33Y 40/20; B33Y 50/02; C22C 38/18; B22F 2203/11; B22F 2301/35; B22F 2998/10; B22F 2999/00

(57) ABSTRACT

Machinery and a method for additive manufacturing (AM) which utilizes a thermal processing heat source to control the thermal profile of metal AM printing of iron-chromium-carbon steels that undergo phase transformations. The method has particular application to control the preheating and cooling rate of directed energy depositions of Creep Strength Enhanced Ferritic Steel including ASTM Grades P91, P92, and P122. The AM machinery includes multiple temperature sensors, and a controller connected to all electromechanical components of the machine to control the heating and cooling to achieve the desired mechanical properties and microstructure of the 3D printed part.

### CROSS-REFERENCE TO RELATED APPLICATIONS

The present application claims priority to U.S. Provisional Application No. 63/539,028, entitled “Integrated Additive Manufacturing and Thermal Processing Method For Microstructure Control”, filed Sep. 18, 2023, which is incorporated herein by reference in its entirety.

This invention was made with government support under DE-SC0023735 awarded by U.S. Department of Energy, Office of Science, Office of Nuclear Energy. The government has certain rights in the invention.

### BACKGROUND OF THE INVENTION

The present invention relates to additive manufacturing and integrated thermal processing, particularly the methods and implementation of an integrated additive manufacturing and thermal processing method designed to build three-dimensional (3D) parts with layer-based, additive manufacturing techniques to achieve the desired 3D printed part mechanical properties and microstructure.

Advanced or additive manufacturing (AM) can create materials with enhanced performance and facilitate rapid development cycles relative to conventional processes. AM, also called 3D printing, is generally a process in which a 3D object is built by adding material to an underlying substrate to form a 3D part rather than subtracting material as in traditional machining. For purposes herein, the term “substrate” includes the base object upon which the AM is deposited (also referred to as printed) including a build plate, print bed, previously deposited layers, and an existing part, such as for a repair of modification. Using one or more additive manufacturing techniques, a three-dimensional solid object of virtually any shape can be printed from a digital model of the object by an additive manufacturing system, commonly referred to as a 3D printer. AM technologies have allowed for the fabrication of complex geometries without the need of tooling, molds, or dies while also limiting material waste.

Metal AM is growing at an exponential rate, fueled by the need for decreased development times, reduced tooling costs, and integrated functionality. The AM process heats feedstock, typically in the form of metallic powders or wires, above the alloy's melting temperature to build successive layers from virtually any alloy composition or mixture, allowing for quick materials development and evaluation. Additionally, there is a sense of urgency in AM process and part development—applications can benefit from rapid development for physical prototypes or low volume production.

With reference to FIG. 1, Metal AM processes fall into two categories: Directed Energy Deposition (DED) and Powder Bed Fusion (PBF), with distinctions based on the primary heat source. These primary heat sources can include laser, electron beam (EB), or electric arc (e.g., wire arc additive manufacturing (WAAM), gas tungsten arc additive manufacturing (GTAAM), or plasma arc additive manufacturing (PAAM) among others. Design freedom and significant part count reduction can be realized by eliminating or reducing the need to assemble multiple components into a single part. Additionally, the rapid solidification rates of AM can produce non-equilibrium microstructures, enabling site-specific tailored properties and compositions that are difficult or impossible to achieve with conventional cast or wrought alloys. However, the progressive layer-by-layer build process, with each layer experiencing multiple steep temperature gradients and variable cooling rates, affects the metallurgical quality of the components. These spatially variable thermal cycles result in location dependent, inhomogeneous microstructure and properties throughout the part.

As a result, nearly all high performance AM builds undergo post processing heat treatments (PPHT) to unify properties. This includes austenitic and solid solution strengthened alloys which may receive high temperature (>1000° C.) solution annealing, aging, hot isostatic pressing, or combination thereof. Martensitic alloys may receive a solution quench+temper heat treatment, or only a tempering step. In any case, these off-line thermal cycles come at additional time and cost penalties, like post weld heat treatment (PWHT). More importantly, heat treatments may be difficult to achieve in complex or large components. Moreover, conventional AM and post built thermal treatments often result in failures. As illustrated in FIGS. 3 and 4, these include excessive distortion and cracking due to uncontrolled cooling profiles of the freshly solidified melt region. In some cases, the need for final heat treatment can become the limiting design or size criteria.

Moreover, conventional PPHT can be a bottleneck in the process: printed parts must be sent to a separate energy, time and cost intensive thermal cycle. This can limit AM application due to size limits for PPHT, or ruin parts due to thermal cycling of complex, variable thickness integrated assemblies with large residual stress distributions.

Welding, which represents a simplified AM deposition process, often requires conventional PWHT with localized heat implements applied hours or days after the initial weld joint has fully cooled, or batch heating on the entire structure. Such approaches are the industry standard, with regulatory approvals structured around this conventional solution; hence conventional AM PPHT leverages these methods. Engineering design and safety codes (e.g., American Society of Mechanical Engineers (ASME) boiler and pressure vessel, power and process piping, and nuclear codes; National Board Inspection Code (NBIC), petrochemical industry codes) may require specific joint preheating and post weld heating temperatures and times, designed to limit the final hardness and brittleness of the weld. Similar codes are in development for post processing of AM builds; these leverage existing heat treatment codes and industry standards. U.S. Patent Publication No. 2002/0170634 describes a modification to conventional PWHT processing with extended hold times at elevated temperatures followed by slower than air cooling for already created weldments; a localized approach is described in U.S. Pat. No. 9,840,752. However, these methods require lengthy secondary processing and can cause excessive distortion of the structure or cracking of the welded joint, or similar cracking and distortion of an AM-built part.

Alternative approaches seek to modify AM process parameters, such as speed, power, scanning strategies and preheat, as an attempt to control cooling rates and resulting microstructural features. As an example, U.S. Pat. No. 10,357,829 teaches that certain regions of a 3D print may have different cooling rates dependent on part geometry, deposition power, speed and hatching patterns. The controlled heat input of the melting process is used to define the residual microstructure, but this approach has geometry, material and consistency limitations. This may be helpful for some feedstocks and limited volumes, but PPHT are still favored to mitigate deleterious build effects and residual stresses in high performance alloys.

For example, Alloy 718 (nickel superalloy) can form different precipitating phases depending on cooling rate; some can be beneficial at high temperatures (y′ and y″), whereas others (δ and Laves) are detrimental and various PPHT cannot always eliminate these. Similarly, residual stresses in 316 stainless steel are known to initiate stress corrosion cracking and early crack propagation in light water nuclear reactor environments. Modifying AM heat inputs to mitigate thermal strains results in the formation of austenite and martensite, rather than the expected austenitic phase for 316L; excursions in the 500-800° C. range sensitize these alloys with Cr-carbide grain boundary precipitation. As a result, prints are still subject to PPHT to restore properties closer to that of wrought alloys. While parametric studies eventually settle on an optimum set of AM parameters, optimizing the heat input for each combination of material and part geometry is not feasible as a long-term solution.

Others will attempt to exploit the AM thermal inhomogeneity as an in-situ heat treatment to enhance mechanical properties. For example, with careful selection of process parameters, multiple DED build layer passes can provide tempering in localized regions to achieve improved properties in Grade 91 Creep Strength Enhanced Ferritic (CSEF) steel. However, this approach relies on the melt layer conducting heat to neighboring layers. This secondary heating depends on spatial and temporal variations controlled by the melt region, with varied properties from the base plate to the final layer. An analogy exists in welding which has temper bead or “controlled fill welding” and has succeeded in obtaining code case approval. U.S. Patent Publication No. 2003/0038167 describes multi-pass weld joint build up followed by a cap weld layer which can be used to temper previous weld layers. Thus, while thermal inhomogeneity can be exploited to provide in-situ heat treatments, it still suffers from layer-to-layer variations.

Alternate methods have been developed to mitigate thermal strains during printing. These include preheating the raw feedstock or the print bed volume above room temperature but below the melting temperature of the material (as described in U.S. Pat. No. 11,260,475), which can reduce residual stresses between build layers. Other approaches utilize the primary print heat source as a steerable preheat means, including the scanning of areas immediately preceding the deposition track with a laser, electric arc or plasma, electron beam, or even an extruder (for plastic printing). While these preheating approaches can overcome some of the conventional difficulties with AM print quality, parts still may require PPHT to ensure reliability in service.

As another approach to improve as-printed AM part quality entails integrating an inline peening head following the print head to impart compressive stresses to the build. It is known that imparting residual compressive stresses on surfaces reduces cracking tendencies in cyclic loading; an analogy is ultrasonic impact treatment to improve the fatigue resistance of welded structures whereby a device strikes the weld toe with a needle striker. Alternate approaches seek control of layer-by-layer properties, including localized ultrasonic vibration, shock peening, or a combination of both after each printhead pass. Lastly, brute-force methods have been suggested whereby the print is paused mid-build when stresses reach a predetermined level, and the entire build chamber is thermally cycled with heaters and coolers to provide intermediary stress relief, or another approach where the printhead laser is used post-build to thermally scan the part for residual stress mitigation. However, this process is slow and difficult to control, requiring multiple passes and not suited for varying AM geometry.

Other AM methods have been suggested to circumvent fabrication difficulties in particularly sensitive alloys. These include hot isostatic pressing and variants of diffusion bonding processes on solids and powders, sometimes with additional heat sources such as hybrid laser-diffusion and friction stir welding. Alternatively, some use CAD/CAE and numerical modeling to predict as-printed residual stress field and distortion a-priori, then morph the build geometry to offset these effects. While feasible for certain components or to create functionally graded shield or cooling layers, complex geometries preclude universal usage.

Similarly, newer materials are being developed to alleviate some of the inherent challenges with AM fabrication and PPHT. These include nano-strengthened alloys, modifications of existing alloys, and new high temperature materials, developed with conventional methods or computational modeling. However, conservative industries will favor using materials with extensive property databases, and technologies which facilitate their use will be preferred. Such is the case for the power generation industry with Grade 91 and similar CSEF alloys favored for their proven history since the 1970s.

Adaptive AM deposition methods have been proposed with arrays of multiple laser beams to increase melting capacity and build speed. One approach includes an arrayed primary multi laser beam shaping system for large area builds without rastering or repositioning the work surface. They note these arrayed primary energy sources can be used for preheating, melting and/or cooling control to control the liquid-to-metal solidification rate. Again, an analogy can be found in hybrid welding with dual heat sources to increase throughput and deposition rates. The addition of a targeted heat source is typically used to pre-heat either or both the base metal and filler metals which will be fused together in the welded joint. These methods seek to increase deposition rate, and do not attempt to control the resultant post-solidification solid state microstructure and residual stress state. Lastly, U.S. Pat. Nos. 7,540,402 and 7,618,503 teach a hybrid welding mode with a thermal processing heat source designed to slow the rate of cooling and resulting hardness as intended for roll formed martensitic stainless steel tubing and other autogenous weldments. Heat is applied as the joint cools below the upper transformation temperature, known as the upper critical temperature (A_{C3}).

Unfortunately, these different approaches to processing metal structures suffer from various disadvantages including excess cost, time and/or energy consumption. Moreover, some of these approaches do not provide the best possible mechanical properties, such as an ideal hardness, toughness, ductility, yield strength or tensile strength.

### BRIEF SUMMARY OF THE INVENTION

Disclosed herein is machinery and a method for additive manufacturing of components which utilizes a thermal processing heat source to control the preheating and cooling rate of a metal additive manufacturing (AM) print of iron-chromium-carbon steels that undergo phase transformations. For purposes, herein, metal additive manufacturing (AM) will also be referred to herein as directed energy deposition; this also refers to powder bed fusion processes. The method has particular application to control the AM print preheating and cooling rate of Creep Strength Enhanced Ferritic Steel. Creep Strength Enhanced Ferritic Steels (“CSEF”) are well defined and understood in the metallurgical arts, and for purposes herein, CSEF steels include high alloy steels that contain between 8% and 13% Cr, small amounts of Mo, V, Nb, and varying additions of W, Co, B, N, and Ni, in addition to C. The method of combined integrated additive manufacturing and thermal processing has particular application to the CSEF steels identified as ASTM Grades P91, P92, and P122, among others, which are incorporated by reference herein.

In addition, the AM machine of the present invention includes a thermal processing heat source which provides heat to the AM geometry almost immediately after material deposition. The second heat source is integrated into the AM machinery, and a preferred thermal processing heat source may be an induction heater. In an alternative preferred embodiment, a laser diode array or other non-contact heating method provides thermal processing of the AM produced part.

Preferably, the AM machine also includes multiple temperature sensors, and a controller connected to all aspects of machine including to the directed energy deposition equipment including the initial heat source; to the thermal processing heat source; to the build plate, substrate or print bed, and to any and all temperature sensors. Preferably, the temperature sensors include a sensor for measuring the temperature of the feedstock as deposited, a sensor for quantifying the heat input by the thermal processing heat source, and a heat source for quantifying the resulting temperature of the deposition. For purposes herein, the term sensor is intended to be interpreted broadly to include embodiments where multiple temperature sensors are combined into one apparatus, such as a single infrared IR camera that can measure the process temperature of one or more independent sources of heat, including the feedstock, part and thermal processing heat source. The controller includes all processing, memory and software to control all aspects of the AM manufacturing and thermal processing.

AM deposition head is capable of real-time in-situ thermal control of the build microstructure and residual stress state. A controller is preferably coupled to the heat source head, using operator, modeled, or real time sensor feedback for integrated process control. This decoupling of the primary energy source (melt control) from the thermal processing heat source (preheat and/or direct cooling control) can enable increased flexibility in AM feedstock selection and result in mechanical and physical property improvements that can greatly expand design opportunities. This embodiment could be used in a fixed or movable build head mechanism to control the build geometry thermal profile and resultant microstructure and stress state.

The method is applied to metal AM parts, including CSEF and ferritic/martensitic steels in real time as the deposition is made. Heat is applied from the thermal processing heat source to the metal part after it has solidified and cooled to below the Martensitic Start (Ms) temperature for the metal feedstock, but prior to the metal part cooling below the Martensitic Finish (Mf) temperature (or ambient temperature), whichever is greater. Heat from the thermal processing heat source is maintained on the part for sufficiently long time to modify the resulting solidified metallic microstructure, phase and precipitate distribution of the metal. This controlled transformation results in reduced deposition-zone residual stress and controlled hardness, ductility, toughness, yield strength and tensile strength.

Thus, it is an object of the invention to overcome the difficulties associated with AM fabrication without lengthy off-line pre- and/or PWHT.

Other features and advantages of the present invention will be appreciated by those skilled in the art upon reading the detailed description which follows with reference to the drawings.

### BRIEF DESCRIPTION OF THE DRAWINGS/ATTACHMENTS

FIG. 1 is a schematic of the conventional AM and post processing heat treatment;

FIG. 2 is a schematic of the integrated additive manufacturing and thermal processing method;

FIG. 3 is a first image of a typical AM failure due to residual stresses and thermal distortion.

FIG. 4 is a second image of typical AM failures due to residual stresses and thermal distortion.

FIG. 5 is a first plot of deposition hardness and photomicrographs of the deposits using conventional AM on Grade 91 CSEF steel including considerations of hardness and distance from the substrate;

FIG. 6 is a second plot of deposition hardness and photomicrographs of the deposits using conventional AM on Grade 91 CSEF steel including considerations of tempering percentage and layer number;

FIG. 7 is an illustration of the AM machinery including integrated thermal processing including electric arc directed energy deposition testing, using an induction coil as the thermal processing heat source;

FIG. 8 is a block diagram of the AM machinery including integrated thermal processing;

FIG. 9 are plots of conventional, integrated thermal processing, and conventional off-line PPHT of electric arc directed energy depositions gas tungsten arc welding (GTAW) of Grade 91 CSEF steel;

FIG. 10 is graph illustrating yield strength for conventional (baseline) and integrated wire arc AM (WAAM) Grade 91 SSJ3 specimens tested at 25, 300, 450 and 600° C. (jittered to show overlapping data);

FIG. 11 is a graph illustrating ultimate tensile strength for conventional (baseline) and integrated WAAM Grade 91 SSJ3 specimens tested at 25, 300, 450 and 600° C. (jittered to show overlapping data); and

FIG. 12 is a graph including three violin plots for build and transverse directional scans of microhardness of Grade 91 WAAM specimens (HV0.2 Carat 940 10 s dwell) processed in three different manners including conventional (baseline as printed, PPHT (1350° F. (730° C.) for 30 min)), and optimized integrated thermal processing.

### DETAILED DESCRIPTION OF THE INVENTION

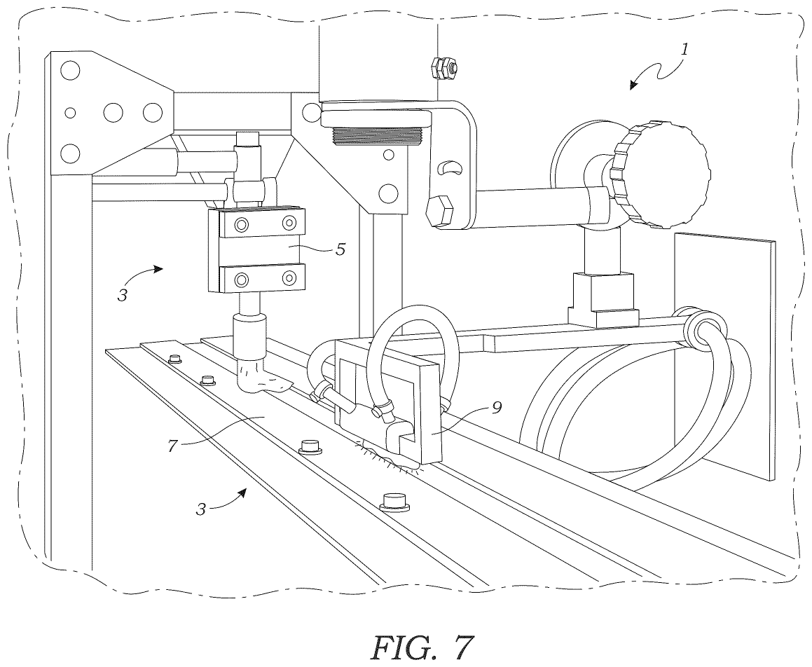

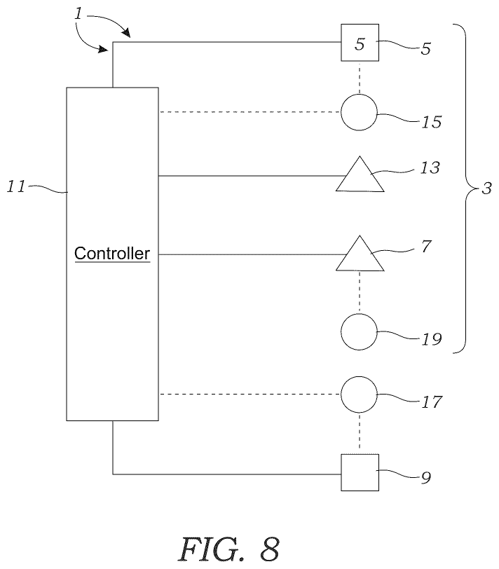

Although the following description refers specifically to metals additive manufacturing and particularly to AM of CSEF steels, the present invention is applicable to any iron-chromium-carbon steel which is desired to have a controlled deposition and resultant microstructure, phase and precipitate distribution, and residual stress state, maintaining design freedom without subjecting the part to a separate PPHT. It is another aspect of the disclosed embodiments to provide a method and system for solid state cooling rate control and in situ heat treatment in metal additive manufacturing. To this end, as illustrated in FIGS. 7 and 8, the AM machine 1 for solid state cooling rate control and in situ heat treatment of the present invention, also referred to herein as an “integrated additive manufacturing and thermal processing assembly 1” includes the standard equipment 3 for depositing AM layers. Acceptable machinery 13 for providing the directed energy deposition may be accomplished using binder jetting, arc, electron beam, laser or hybrid directed energy deposition (DED), powder bed fusion (PBF), material extrusion, material jetting, among others, which are collectively referred to herein as “AM machinery” or “directed energy deposition machinery”. In addition to the directed energy deposition machinery 13 for depositing the AM geometry, the integrated additive manufacturing and thermal processing assembly 1 includes an initial heat source 5 which heats the metal feedstock to a molten state. As illustrated in FIG. 7, the heat source 5 is preferably in close proximity to the AM machinery's nozzle, such as to melt metal powder or wire, immediately before being fused (or deposited) upon the underlying substrate 7. As illustrated in FIG. 7, the substrate 7 is a moving conveyor build plate. Alternatively, a moving AM head and heat source 5 can print onto a stationary print bed, or any combination of moving/stationary heat sources and build geometries can be used. However, the term “substrate” also includes the previously deposited layers, or an existing part, such as a part needing repair of modification.

Referring to FIGS. 7 and 8, the general configuration of the integrated additive manufacturing and thermal processing assembly 1 is shown. In addition to the traditional components 3 of AM manufacturing, the AM machine of the present invention includes a thermal processing heat source 9 which provides piece-wise heat to the AM part almost immediately after material deposition. A preferred thermal processing heat source is an induction heater. In an alternative preferred embodiment, a laser diode array or other non-contact heating device may be integrated into the AM machinery 1 as a thermal processing heat source. This thermal processing heat source could be used in a fixed or movable mechanism attached near the primary AM heat source, providing addressable control of the build deposit thermal profile and resultant microstructure and stress state. In certain embodiments, contact methods may be used, such as resistive or conductive heaters, or even electrical Joule heating of the deposit itself. Still other heat sources may be employed.

With reference to FIG. 8, the integrated additive manufacturing and thermal processing assembly 1 includes multiple temperature sensors 15, 17, 19 which measure the temperature of the feedstock pre-deposition, pre- and post- the thermal processing heat source, and the part/print bed, respectively. The temperature sensors 15, 17, and 19 may consist of three temperature sensors positioned in-situ, such as thermocouples, non-contact pyrometers or other sensing devices. Alternatively, the temperature sensors may be combined into one or more assemblies, such as by using a single infrared (IR) camera to measure the temperature at two or more locations. Alternatively, the temperature sensors 15, 17, and 19 may comprise a combination of one or more thermal cameras and/or in-situ sensors placed adjacent to the feedstock, the thermal processing heat source, and the part/print bed.

With reference to FIGS. 7 and 8, the integrated additive manufacturing and thermal processing assembly 1 includes a controller 11 which is connected to the temperature sensors 15, 17, and 19, as well as to all electromechanical elements of the assembly including the directed energy deposition equipment 13, feedstock heat source 5, the print bed 7, and thermal processing heater source 9. The controller 11 includes the hardware and software to provide operator, modeled, or real time sensor feedback for integrated process control. This decoupling of the primary energy source 5 (preheat-melt control) from the thermal processing heat source 9 (direct cooling control) can increase the flexibility in AM feedstock selection and result in mechanical and physical property improvements that can greatly expand design opportunities.

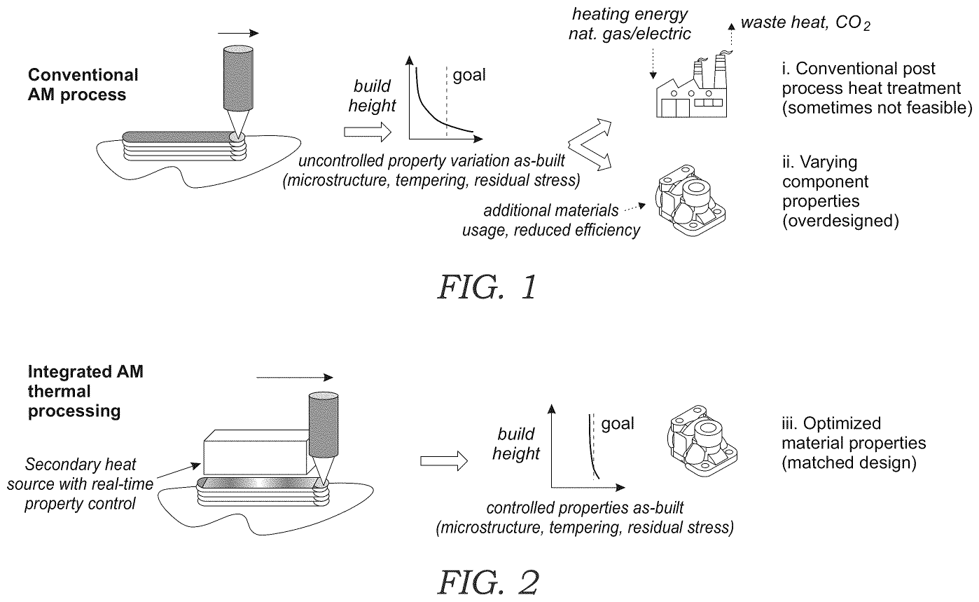

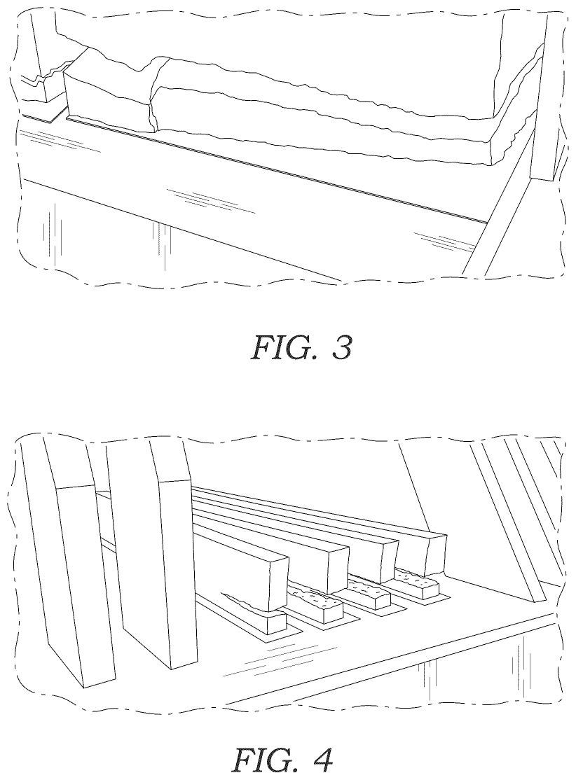

Referring to FIGS. 1 and 2, the general steps performed by the integrated additive manufacturing and thermal processing method of operation is shown in comparison to conventional AM and post build thermal treatments. The dual heat source AM machinery and integrated thermal processing assembly is capable of real-time in-situ thermal control of the build microstructure and residual stress state. Those skilled in the art will recognize that while some time and/or distance ranges from pre-heating to printing and post-heating are described herein, different materials will have different temperatures, heating rates, and cooling rates, the determination of the time range depends on the material, and such determinations are within the scope of the present disclosure and within the skill of those in the art.

The process is accomplished with the addition of a thermal processing heat source to provide thermal processing heating immediately following AM melt pool solidification. Preferably, heat is applied piece-wise to the part from the thermal processing heat source after it has solidified and cooled to below the Martensitic Start (Ms) temperature for said feedstock. However, it is preferred that the heat be applied to the metal part prior to the metal part cooling below the Martensitic Finish (Mf) temperature of the feedstock or ambient temperature, whichever is greater. Thereafter, the thermal processing heat source continues to heat the metal part for sufficiently long time so as to reduce the hardness of the metal part.

Certain embodiments of the present invention include, but are not limited to, wire arc additive manufacturing including a primary heat source with wire feed closely coupled to a single sided induction coil with infrared pyrometer feedback to the controller. Other primary and secondary dual heat sources may include a combination of laser, gas metal arc additive manufacturing, plasma arc additive manufacturing, electron beam, induction or solid-state (i.e., friction stir additive manufacturing). AM processes may be single material or use multiple composition powders, feedstocks, baseplates or dissimilar filler wire compositions for functionally graded part compositions. The coupled design with adjacent primary-thermal processing heat sources allows for independent control of the melt pool operation (e.g., deposit width, depth, deposition rate, travel speed) through the primary heat source and the volumetric cooling profile by the thermal processing heat source. Linear, arrayed and curved deposits of materials of varying thickness are possible with such an arrangement, including but not limited to large geometry with unsupported build geometry and varying thick-thin-solid-hollow sections.

As demonstrated, a solid state high frequency induction heater 9 can offer digital control of induction frequency, heat penetration depth and width, and overall power when used as a thermal processing heat source. Control of these parameters, and location of the thermal processing heat source with respect to the primary AM heat source, can define various cooling-control profiles within the build volume. For example, the integrated thermal processing heat source may be rigidly mounted trailing to the primary heat source 3 to provide cooling control. In another embodiment, the thermal processing heat source may be controllable in distance and direction from the primary heat source, allowing for pre-deposition heating and/or post-deposition heating depending on location. In another embodiment, there may be multiple addressable thermal processing heat sources to allow for thermal control in any direction and depth. A controller and temperature feedback sensor may provide real-time adjustment of the induction head distance to the workpiece, frequency and power, effecting a change in the volumetric heating and cooling rates of the build geometry. Induction heat penetration depth varies non-linearly with spacing to the workpiece, resonant frequency and coil shape, offering non-surface heating and tailorable microstructure control.

Immediate temperature feedback can be provided by non-contact means such as infrared pyrometers or machine vision thermal camera systems measuring deposit surface temperature, among other non-contact and contact-based methods. In other embodiments, a digital twin or model of the system can provide a-priori knowledge of working temperatures and thermal processing heat source power. On some systems, thermocouples can be affixed to expected heat conduction zones (print beds/build plates before deposition or on build geometry when the system is paused mid-print) to control and monitor temperature profiles as function of time.

In a post heating mode embodiment, particularly for hardenable alloys which undergo a martensitic solid-state transformation upon cooling, the present invention can provide elevated temperatures for enhanced diffusion of undesirable elements, gases or precipitates within the solidified melt zone. Additionally, another embodiment of the present invention allows for tempering and control of freshly formed martensitic microstructures, reducing brittleness and increasing toughness.

The present invention is readily adaptable to arc, laser, and electron beam AM processes, within controlled 3D printing device volumes or on larger robotic gantry DED components which include: a moving heat source and formation of a fusion zone with recirculating, liquid metal that travels along with the heat source. Primary AM cooling rates can vary significantly (powder bed fusion (PBF): 10⁵-10⁷ K/s; DED: 10²-10⁵ K/s), along with temperature gradients (PBF: 10⁶-10⁷ K/m; DED: 10⁴-10⁶ K/m) with solidification growth rates spanning four orders of magnitude; wire arc additive manufacturing thermal profiles may be considered which are on the low end of the DED ranges and provide guidance for process validation.

In wire arc additive manufacturing, experiments have shown the thermal processing heat source of the present invention in a post-heating embodiment allows for a near immediate relaxation of longitudinal shrinkage tensile stress and provides excellent mobility for any trapped hydrogen to escape the weld matrix. Hard martensitic structures pose a great risk of delayed cracking under the influence of residual stresses in the presence of hydrogen, which is preferentially trapped in high stress regions and structural defects such as grain boundaries, dislocations, and carbide/matrix interfaces. Greatest benefits are observed by immediately reheating the solidified deposit near the lower critical transformation (A_{C1}) temperature after solidification, with heating parameters dependent on primary heat source travel speed and material thickness. This lower critical temperature is a function of the local alloy composition.

Experiments were conducted on FM and martensitic stainless steels, ferromagnetic alloys primarily of chromium and carbon, capable of achieving ultimate tensile strengths of 500-2,000 MPa. The present invention has been applied to the most common martensitic stainless steel, AISI Type 410 (UNS S41000) to solve many of the historical difficulties associated with this alloy family and promote transformation of the solidified deposit and HAZ into tempered martensite and very fine carbides. Thus, reducing brittleness and eliminating cracking while improving ductility and toughness. The fundamental materials science behind FM transformations in Fe—Cr—C steels governs the approach. In these quench hardenable steels, rapid secondary heating shifts the lower critical (A_{C1}) temperature for austenite formation above that of the equilibrium value. The process exploits this: rapid secondary heating >100° C./s allows for quick excursions to, or even slightly above, the A_{C1} value. In addition, rapid heating shifts the upper critical (A_{C3}) temperature even higher, expanding the process window. Martensitic start and finish temperatures also play a major role in cooling profile tuning; compounding all of this is the fact that transformation temperatures are a function of prior austenitization temperature, which vary throughout the deposited layer. They can also change as a function of material composition, which could occur locally across the melt region due to segregation, coarsening, precipitation or other effects. As a secondary point of reference, the A_{C1} temperature for “9Cr” CSEF steels such as Grade 91 with nominal 9 wt. % chromium content is approximately 810° C. (1490° F.).

In the post-heating embodiment, the present invention allows for tuning the primary AM heat (melt) head, with the additional thermal processing heat source providing thermal control of the freshly deposited and thermally cycled lower layers. The net effect is independent control over solidification parameters (such as grain size and porosity) while allowing for more control of final microstructural condition (phases, precipitates, and residual stresses). This contrasts with current approaches which juggle melt power, layer thermal cycling and heat input to avoid detrimental microstructures. Another embodiment of the present invention can use integrated model-informed understandings of the transient, three-dimensional temperature fields for prediction and real-time tuning of the process on a wide variety of materials.

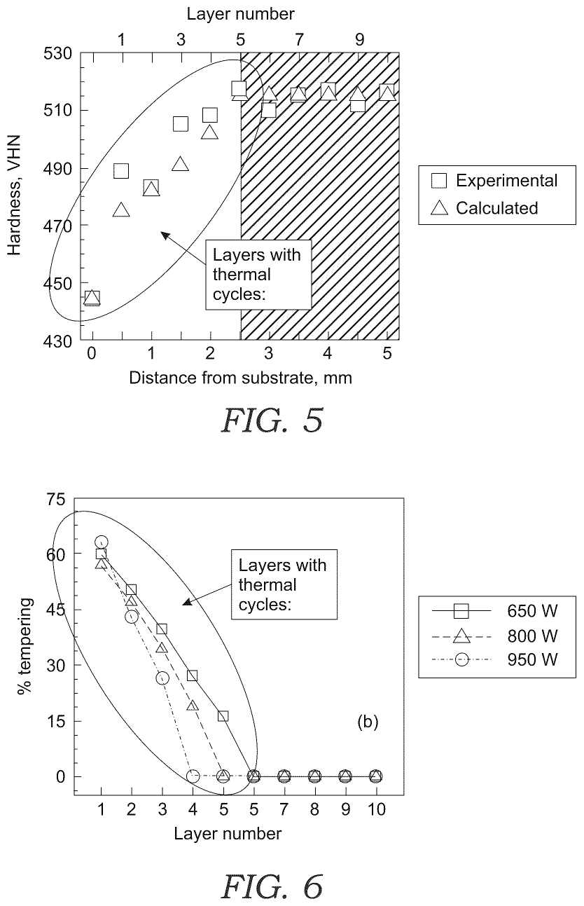

Referring to FIGS. 5-6, typical hardness profiles of conventional AM using in-situ tempering on FM steel are plotted. Depth of tempering is affected by the primary heat source power settings and show variability across the height to the build due to varying cooling rates.

Referring to FIG. 7, the experimental integrated deposition and thermal processing test sled is shown. This device allows for controlled testing of the process on various alloys, including CSEF steel using a initial gas tungsten arc welding (GTAW) torch and thermal processing heating and control using non-contact induction heating and temperature sensing equipment. Experiments were carried out on Grade 91 CSEF steel on 3 mm thick square edge butt-joint autogenous and wire-feeding GTAW configurations. The process was accomplished with the thermal processing heat source in close proximity to the initial heat source providing thermal processing heating immediately following molten pool solidification. A single sided induction coil with infrared pyrometer feedback was found effective with greatest benefits observed by reheating the weld seam after solidification and with heating parameters dependent on travel speed and thickness. This integrated thermal processing has been applied to resistance and gas tungsten, gas metal, and plasma arc (GTAW, GMAW, PAW) deposits for production of martensitic (410, 420) and martensitic-aging (15-5PH) stainless steel seam welded tubing, stamped and formed sheet and plate structures. Integrated weld processing is done in real time, without subjecting the assembly to a separate PWHT which is associated with risks of distortion and cracking.

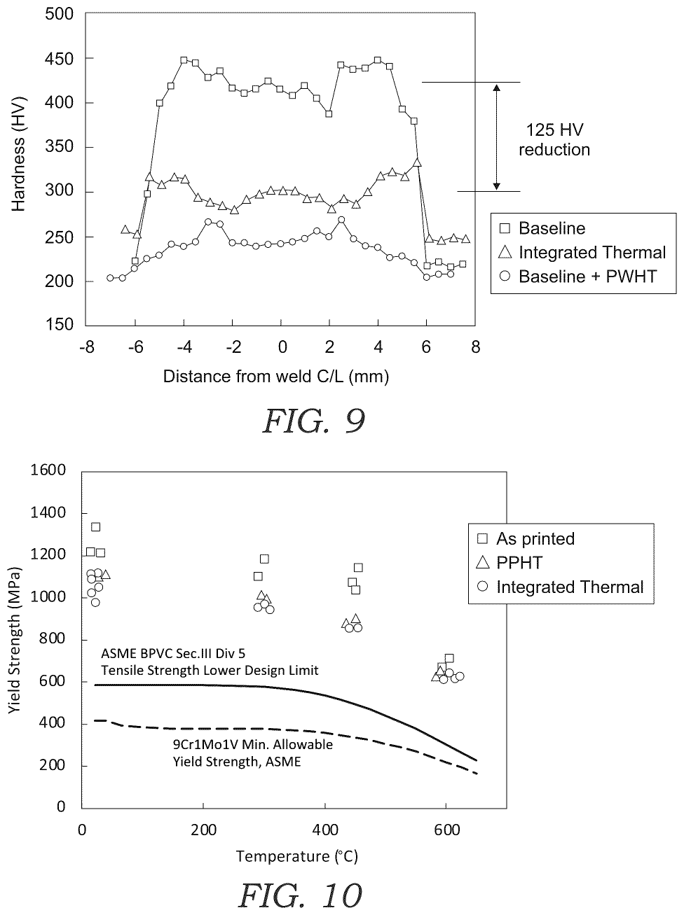

Referring to FIG. 9, the measured CSEF deposit microhardness is plotted for the aforementioned experiments. For comparison, results are included from conventional processing (baseline) and conventional processing with an off-line PWHT. CSEF steels exhibit high hardness in the solidified fusion zone and heat affected zone upon AM deposition with conventional methods, often exceeding 400 HV. Conventional off-line PWHT is known to reduce hardness in these zones to that near the base metal hardness, 200-250 HV in this case for Grade 91. Optimum integrated AM and thermal processing results in a 125 HV reduction in weld fusion and heat affected zone hardness, nearly approaching that of a conventional PWHT.

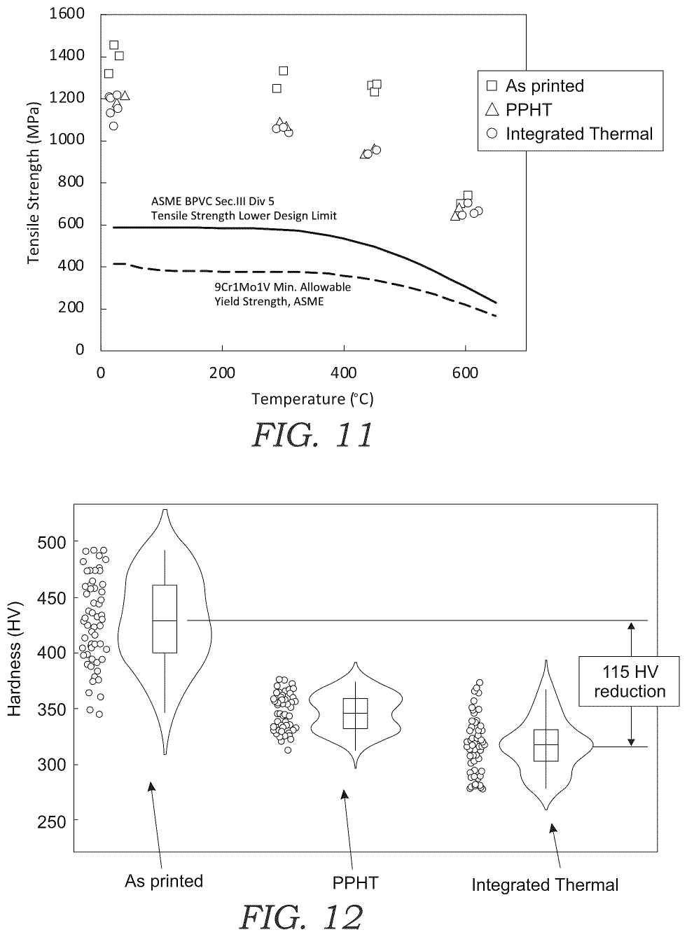

With reference to FIGS. 10 and 11 illustrates yield strength and ultimate tensile strength of WAAM Grade 91 builds machined into SSJ3 subsize specimens which were tested “as printed”, after PPHT, and after undergoing integrated thermal treatment in accordance with the current invention. Experiments were carried out on an initial wire arc AM (WAAM) wire-feed torch and thermal processing heating and control using non-contact induction heating and temperature sensing equipment. Specimens were created using 0.035″ Grade 91 CSEF steel feedstock (ER90S-B9) with a 3-axis CNC AM machine, with the print head articulated on the Z-axis and the mild steel build plate controllable in the X-Y directions. The process was accomplished with the thermal processing heat source in close proximity to the initial heat source, providing thermal processing heating immediately following AM deposit solidification. Narrow wall AM geometry was created (120 mm long, 22 mm high, 7 mm wide), in addition to curved, thick and complex test geometry with various number of layers and deposition track strategies. The specimens were tested at 25, 300, 450 and 600° C. For comparison, ASME BPVC code design and allowable values for Grade 91 wrought material is shown. As shown in FIGS. 10 and 11, the integrated AM thermal processing results in more consistent yield strength relative to as printed specimens across all temperatures tested, with 21% and 54% less variation at room temperature and 600° C., respectively. As expected, the PPHT reduced strength as the martensitic microstructure is tempered. However, the integrated AM thermal processing also reduced strength to similar values, but without requiring the time, energy and costs of a separate PPHT.

With reference to FIG. 12, the aforementioned WAAM Grade 91 SSJ3 specimens “as printed”, after PPHT, and after undergoing integrated thermal treatment were also tested for microhardness. The integrated AM thermal processing showed more homogenous microhardness distribution than conventionally printed walls. The reduction in average hardness even exceeded that of an off-line PPHT (achieving 140% reduction relative to PPHT).

The AM and integrated thermal processing of the present invention has unlimited uses including improving the characteristics of materials which are expected to undergo uniquely hostile environments such as the components within nuclear fusion or fission reactors. The uniquely hostile environment within fusion and fission reactors poses extreme challenges for components. Materials can experience high thermal flux, intense irradiation fields, high stresses, and be exposed to reactive fluids and gases. Thus, any material solutions must be scalable, sustainable, and low cost with reliable and accelerated development times. Gen. IV reactor designs favor high temperature alloys for structural materials with an anticipated operational window between 350-650° C. or higher. Below the lower limit, irradiation-induced hardening and embrittlement is a strong concern. High temperature limits are typically governed by thermal softening effects, specifically creep strain rates and creep-fatigue performance. Materials in this operating regime must meet strict performance requirements. The ASME Boiler and Pressure Vessel Code guides implementation of approved materials which include Type 304 and 316 austenitic stainless steels, Alloy 800H (Ni—Fe—Cr), Alloy 617 (Ni—Cr—Co—Mo), and CSEF steels such as 2.25Cr-1Mo (Grade 22) and 9Cr-1Mo-V (Grade 91). Research literature and industry provide a wealth of material performance data for these alloys. However, service experience has confirmed what theory predicts: failures can occur in components very early in life if the required microstructure is not developed and/or maintained during processing.

In addition, AM in combination with integrated thermal processing of the present invention can produce unique microstructures, with properties exceeding that of conventional methods. However, as mentioned previously, variable solidification parameters and temperature gradients inherent as layers progressively build can change microstructures and impart significant residual stresses, distortion, weakening, or cracking. These variations are compounded in high temperature nuclear materials: specific microstructural features (precipitates, phases) which impart strength, creep, irradiation and corrosion resistance can degrade across an AM print volume. This is apparent in the ferritic/martensitic (FM) materials (e.g., CSEF steels, Grade 91) which possess sufficient Cr and C content that they respond to heat treatments—rapid cooling from the austenitization temperature results in a martensitic microstructure. These steels are nominally processed for high strength and toughness through subsequent treatments to obtain tempered martensite along with MX and M₂X carbo-nitrides, and M₂₃C₆ carbide precipitates. CSEF alloys are favored by the power generation industry for their cost-effective pressure boundary performance at elevated temperatures and are used in a variety of power generation and high temperature process applications including heat exchangers such as heat recovery steam generators (HRSGs), superheaters, boilers, reactors, pressure vessels and piping. AM deposition without additional heat treatments creates brittle untempered martensite which severely reduces ductility. Additionally, any concerns about radiation-induced degradation of mechanical properties in the heat affected zone (HAZ) of weldments would apply to AM as-printed parts. Irradiation displacement damage can increase disparities of strength (preferential hardening of base metal and the weld fusion zone, reducing ductility and toughness), increasing the likelihood of HAZ local deformation and cracking. The present invention can be applied to these alloys for enhanced properties and performance of both AM builds and in-situ repair AM deposition processes.

Modifications of CSEF alloys have been identified for use in fusion reactor structural components. Reduced activation ferritic-martensitic (RAFM) steels exhibit the same behavior upon AM deposition: high hardness fusion and heat affected zones as compared to wrought metal. Hence, fusion reactor development has assumed the need for conventional off-line heat treatment of RAFM structures to reduce brittleness, cracking tendencies, and restore high temperature creep performance. However, the thermal processing itself can result in additional risks such as distortion, or even heat treatment-induced cracking. In fusion-specific applications, this is compounded from dissimilar material stacks and varying thicknesses throughout large structural modules. Again, the present invention can be applied to microstructural control of these materials for improved AM part quality and performance, transforming the build volume into tempered martensite and very fine carbides without requiring a lengthy off-line PPHT.

Accordingly, it will be apparent that various modifications can be made without departing from the spirit and scope of the invention. Therefore, having described my invention in such terms such as to enable a person skilled in the art to understand the invention, recreate the invention and practice it, and having presently identified the presently preferred embodiment thereof, we claim:

1. A method of combined integrated additive manufacturing and thermal processing comprising the steps of:
providing a metal feedstock made of an iron-chromium-carbon steel that undergoes phase transformations;
providing an additive manufacturing heat source;
heating the metal feedstock with the additive manufacturing heat source to above the metal feedstock's melting point to form a molten metal feedstock;
depositing the molten metal feedstock in an additive manufacturing process upon a substrate to form a part;
providing a thermal processing heat source and positioning it adjacent to the part;
applying heat from the thermal processing heat source to the metal part after it has solidified; and
maintaining heat from the thermal processing heat source upon the metal part for sufficiently long time so as to effect a microstructural change of the metal part.

2. The method of combined integrated additive manufacturing and thermal processing of claim 1 wherein applying heat from the thermal processing heat source to the metal part commences after it has cooled to below the Martensitic Start (Ms) temperature for said feedstock, but prior to the metal part cooling below the Martensitic Finish (Mf) temperature or ambient temperature, whichever is greater, and maintaining heat from the thermal processing heat source upon the metal part continues for sufficiently long time so as to reduce the hardness of the metal part.

3. The method of combined integrated additive manufacturing and thermal processing of claim 1 wherein the metal feedstock is made of a Creep Strength Enhanced Ferritic Steel is a Fe—Cr—C alloy steel that contain between 8% and 13% Cr.

4. The method of combined integrated additive manufacturing and thermal processing of claim 3 wherein applying heat from the thermal processing heat source to the metal part commences after it has cooled to below the Martensitic Start (Ms) temperature for said feedstock, but prior to the metal part cooling below the Martensitic Finish (Mf) temperature or ambient temperature, whichever is greater, and maintaining heat from the thermal processing heat source upon the metal part continues for sufficiently long time so as to reduce the hardness of the metal part.

5. The method of combined integrated additive manufacturing and thermal processing of claim 1 wherein the metal feedstock is made of a Creep Strength Enhanced Ferritic Steel is an ASTM Grade P91, P92, P122 steel.

6. The method of combined integrated additive manufacturing and thermal processing of claim 2 wherein the metal feedstock is in powder form.

7. The method of combined integrated additive manufacturing and thermal processing of claim 2 wherein the metal feedstock is in wire form.

8. A combined integrated additive manufacturing and thermal processing assembly comprising:
an additive manufacturing machine which includes deposition equipment which deposits molten metal upon a print bed, said additive manufacturing machine further including a reservoir for storing metal feedstock, and a reservoir heat source adjacent said reservoir for heating feedstock in said reservoir to above its melting point;
a thermal processing heat source positioned adjacent to said print bed;
a reservoir temperature sensor which measures the temperature of feedstock in said reservoir;
a thermal processing temperature sensor which measures the temperature of the thermal processing heat source;
a print bed temperature sensor which measures the temperature of an AM part upon said print bed; and
a controller connected to said additive manufacturing machine's deposition equipment, said reservoir heat source, said thermal processing heat source, said thermal processing temperature sensor, and said print bed temperature sensor, said controller further including hardware and software to analyze sensor feedback from said reservoir heat source, said thermal processing heat source, and said thermal processing temperature sensor to provide real-time integrated thermal processing of an AM produced part.

9. The combined integrated additive manufacturing and thermal processing assembly of claim 8 wherein said controller causes said thermal processing heat source to apply heat to an AM produced part made of iron-chromium-carbon steel that undergoes phase transformations after the part has cooled to below the Martensitic Start (Ms) temperature for the part, but prior to the part cooling below the Martensitic Finish (Mf) temperature or ambient temperature, whichever is greater.

10. The combined integrated additive manufacturing and thermal processing assembly of claim 9 wherein said controller causes said thermal processing heat source to maintain heat upon the part for sufficiently long time so as to reduce the hardness of the part.
